(19) United States
(12) Patent Application Publication
(10) Pub. No.: US 2005/0205216 A1
(43) Pub. Date: Sep. 22, 2005

(54) Method and apparatus for installing window coverings

(76) Inventor: Gerrit Jan Vrielink, Richardson, TX (US)

Correspondence Address: W. THOMAS TIMMONS;THE WHITE HOUSE ON TURTLE CREEK, 2401 TURTLE CREEK BLVD, DALLAS, TX, 75219-4760, US

(21) Appl. No.: 11/081,383

(22) Filed: Mar. 16, 2005

Related U.S. Application Data
(60) Provisional application No. 60/554,079, filed on Mar. 17, 2004.

(51) Int. Cl. E06B 9/08

(52) U.S. Cl. 160/23.1

(57) ABSTRACT

A method and apparatus are disclosed for installation of a cassette system for enclosing window coverings hardware, such as roller shade systems and to permit convenient removal of a roller tube assembly from the cassette without the need to take down the cassette itself. A cassette box is provided with two tapered slots at the wall side that match with two tapered cantilevers of the installation brackets. Installation of the cassette box is accomplished by simply lifting the box with its slots onto the bracket. Brackets are available as wall mount brackets, as ceiling mount brackets, and as end brackets for inside mount. The wall and ceiling mount brackets feature tapered cantilevers that precisely match the tapered slots in the cassette box. The tapered shape ensures that the cassette box locks itself firmly into position and tightens itself towards the bracket. The wall brackets include a flat aluminum plate and a carrier flange that is provided with the tapered cantilevers. The bracket height corresponds exactly with the cassette height. The ceiling bracket has two flanges, the carrier flange that has exactly the same cantilever construction but is taller by the amount of the height of the cantilever, and the ceiling mount flange. The ceiling mount flange is provided with a snap-in slot that will accommodate the molding. The snap-on molding of the present invention provides a secure and easy to install aesthetic closure. The molding lock is an integral part of the ceiling bracket. The inside mount end brackets include a wall plate flange and a horizontal support flange. The wall plate flange precisely matches the cassette box end plates. This ensures full light gap closure between cassette and mounting surface. The support flange is slightly flared at front and rear to ensure a safe and stable setting for the cassette system.

### BACKGROUND OF THE INVENTION

1. Field of the Invention

The present invention relates to the installation of roller shades and similar lift systems for window coverings inside enclosures.

2. Description of Related Art

Roller or lift systems for roller shades commonly consist of a rotating tube to which the window treatment or shading material is attached. By rotating the tube the material is either raised or lowered.

The drive end of the tube is provided with either a mechanical rotating clutch device or with an electric motor that activates the rotation. The opposite side of the tube is the non-drive end, which is commonly provided with a round shaft bearing to permit rotation.

The common method of installation of such systems is by means of brackets that function as end supports.

The enclosures currently available are either of the assembly-type where one or more plates are individually clipped onto the end brackets or they are of U-shaped box-like enclosures that are installed either by metal spring clips or by means of drilling through the enclosure into a fixed surface. The drill-through method often leads to practical on-site complications and delays and the spring clips commonly are restricted in the load bearing capacity, and they therefore have restricted application for heavier systems.

Installation of each of these systems is often cumbersome and time consuming. There usually is no easy method to remove the roller tube assembly once it has been installed because that commonly requires removal of the support brackets and complete or partial disassembly of the installed shade.

### SUMMARY OF THE INVENTION

An apparatus according to the present invention includes a cassette to make installation of a cassette system for enclosing window coverings hardware, such as roller shade systems, quick and simple and to permit convenient removal of a roller tube from the cassette without the need to take the cassette itself down. A cassette box is provided with two tapered slots at the wall side that match with two tapered cantilevers of the installation brackets. Installation of the cassette box is accomplished by simply lifting the box with its slots onto the bracket.

Brackets according to the present invention will be available as wall mount brackets, as ceiling mount brackets, and as end brackets for inside mount. The wall and ceiling mount brackets feature tapered cantilevers that precisely match the tapered slots in the cassette box. The tapered shape ensures that the cassette box locks itself firmly into position and tightens itself towards the bracket.

The wall brackets comprise a flat aluminum plate, the carrier flange, that is provided with the tapered cantilevers. The bracket height corresponds exactly with the cassette height.

The ceiling bracket has two flanges, the carrier flange that has exactly the same cantilever construction but is taller by the amount of the height of the cantilever, and the ceiling mount flange. The ceiling mount flange is provided with a snap-in slot that will accommodate the molding.

This construction is an important improvement over the ceiling mount clip-on systems currently on the market. Ceiling clips require space for mounting above the cassette box. This creates a light gap between the cassette box and the ceiling. Prior cassette boxes often have a protruding lip at the room side to close this light gap. As a consequence, the ceiling attachments are no longer accessible and it becomes very difficult to remove the shade or cassette box should repairs be necessary.

The snap-on molding of the present invention provides a secure and easy to install aesthetic closure. The molding lock is an integral part of the ceiling bracket.

The inside mount end brackets comprise a wall plate flange and a horizontal support flange. The wall plate flange precisely matches the cassette box end plates.

This ensures full light gap closure between cassette and mounting surface. The wall plate flanges are provided with four countersunk screw holes for installation. The support flange is slightly flared at front and rear to ensure a safe and stable setting for the cassette system.

The drive-end and non-drive-end end plates form an integral part of the cassette box structure. The plates are provided with four screw holes that match the assembly channels incorporated in the cassette box extrusion. The drive end is provided with either a motor support for a motorized system or with a clutch support for a manual system. The non-drive-end features a bearing support with a plastic shaft-bearing insert. Bearing support and insert are constructed such that the cylindrical bearing shaft of the roller tube idler remains accessible from below after installation of the tube assembly.

It is often necessary to remove a roller shade or lift system tube after installation, either to correct installation or construction error or later on to permit maintenance or replacement. Commonly known systems have no provision for easy removal of tubes after installation. The system is provided with a newly developed spring-loaded idler that permits quick removal of the tube assembly. The idler comprises a sealed cylindrical plastic enclosure that houses an axially movable shaft. The shaft comprises a cylindrical bearing section that is kept in protruding position by means of a metal spring inside the enclosure. The spring action ensures proper positioning of the shaft in the end plate bearing. The shaft end is accessible after installation and can be depressed into the housing to push it back out of the bearing support and take down the roller tube and shade assembly. In the opposite manner, the shaft is depressed while being installed, and it is placed against the end plate bearing bracket. By lining the depressed shaft up with the shaft bearing, the shaft will automatically spring in place and securely position the tube assembly inside the cassette structure.

These and other objects, advantages and features of this invention will be apparent from the following description taken with reference to the accompanying drawing, wherein is shown a preferred embodiment of the invention.

### BRIEF DESCRIPTION OF THE DRAWING

FIG. 1 is an assembly view of apparatus according to the present invention for installing window coverings such as roller shades;

FIG. 2 is a sectional view of a cassette box and ceiling mount bracket according to the present invention; and

FIG. 3 is a perspective view of a spring-loaded idler according to the present invention.

### DESCRIPTION OF THE PREFERRED EMBODIMENT

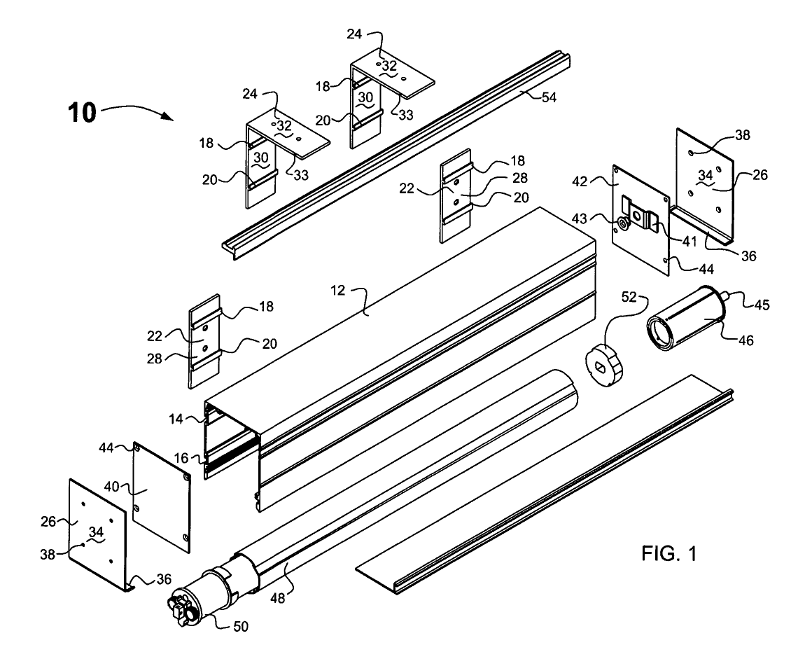

Referring now to the drawing, and in particular to FIG. 1, an apparatus according to the present invention is referred to generally by reference numeral 10. Apparatus 10 includes a square cassette 12 to make installation of a cassette system for enclosing window coverings hardware, such as roller shade systems, quick and simple and to permit convenient removal of a roller tube and shade assembly from the cassette without the need to take the cassette itself down. A cassette box is provided with two tapered slots 14 and 16 at the wall side that match with two tapered cantilevers 18 and 20 of the installation brackets. Installation of the cassette box is accomplished by simply lifting the box with its slots onto the bracket.

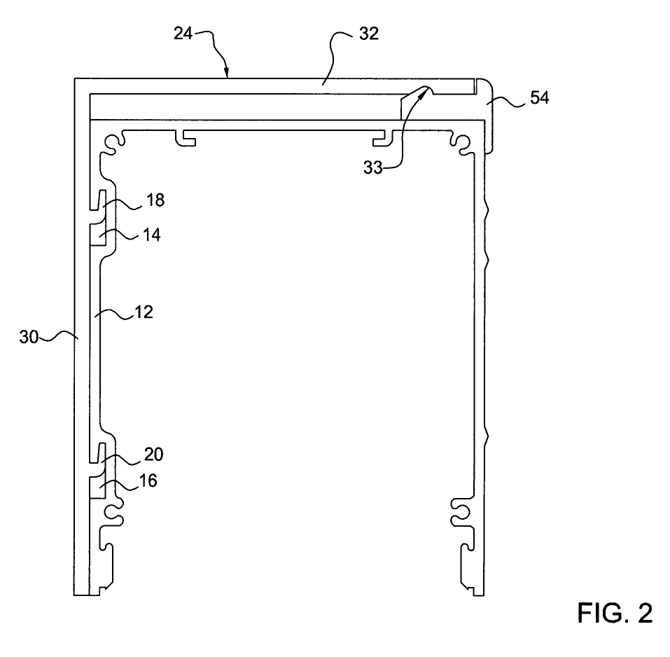

Brackets according to the present invention will be available as wall mount brackets 22, as ceiling mount brackets 24, and as end brackets 26 for inside mount. Referring also to FIG. 2, the wall and ceiling mount brackets feature tapered cantilevers that precisely match the tapered slots in the cassette box. The tapered shape ensures that the cassette box locks itself firmly into position and tightens itself towards the bracket.

Each wall mount bracket 22 comprises a carrier flange 28 which is a substantially flat aluminum plate that is provided with the tapered cantilevers 18 and 20. The bracket height corresponds exactly with the cassette height.

The ceiling mount bracket has two flanges, a carrier flange 30 that has exactly the same cantilever construction as the wall mount bracket but is taller by the amount of the height of the cantilever, and a ceiling mount flange 32. The ceiling mount flange 32 is provided with a snap-in slot 33 that will accommodate the molding.

This construction is an important improvement over the ceiling mount clip-on systems currently on the market. Ceiling clips require space for mounting above the cassette box. This creates a light gap between the cassette box and the ceiling. Prior cassette boxes often have a protruding lip at the room side to close this light gap. As a consequence, the ceiling attachments are no longer accessible and it becomes very difficult to remove the shade or cassette box should repairs be necessary.

Each inside mount end bracket 26 comprises a wall plate flange 34 and a horizontal support flange 36. The wall plate flange precisely matches the cassette box end plates. This ensures full light gap closure between cassette and mounting surface. The wall plate flanges are provided with four countersunk screw holes 38 for installation. The support flange is slightly flared at front and rear to ensure a safe and stable setting for the cassette system.

The drive-end and non-drive-end end plates 40 and 42 form an integral part of the cassette box structure. The plates are provided with four screw holes 44 that match the assembly channels incorporated in the cassette box extrusion. The drive end is provided with either a motor support for a motorized system or with a clutch support for a manual system. The non-drive-end 42 features a bearing support 41 with a plastic shaft-bearing insert 43. Bearing support and insert are constructed such that the cylindrical bearing shaft of the roller tube idler remains accessible from below after installation of the tube assembly.

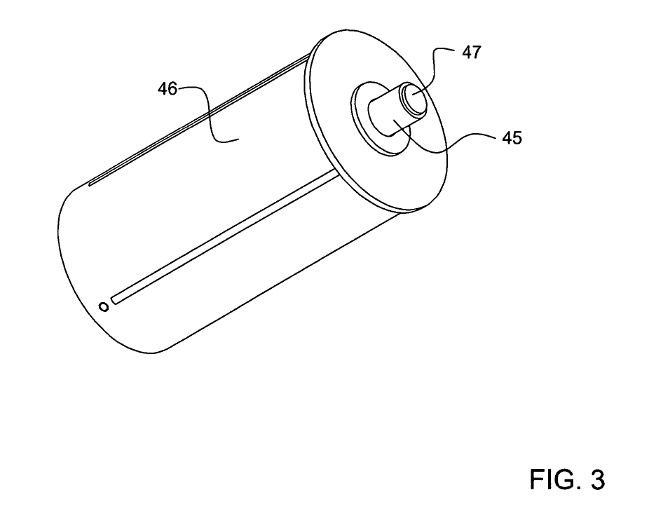

It is often necessary to remove a roller shade or lift system tube after installation, either to correct installation or construction error or later on to permit maintenance or replacement. Commonly known systems have no provision for easy removal of tubes after installation. Referring also to FIG. 3, the system of the present invention is provided with a newly developed spring-loaded idler 46 that permits quick removal of the roller tube assembly, which includes tube 48, motor 50 and drive adapter 52. The bearing support 41 and the plastic shaft-bearing insert 43 have been designed to permit the idler shaft 45 to remain accessible from below. Rather than having to dismount the entire cassette box to remove the roller tube, the roller rube can now be removed by simply inserting a tool to depress the idler shaft 45 until it clears the plastic shaft-bearing insert 43. The end of the idler shaft 45 of the spring-loaded idler 46 has a protruding cylindrical end 47 which is two millimeters smaller in diameter than that of the end of the idler shaft. This provides a ridge which permits one to depress the spring loaded idler shaft until it clears the plastic shaft-bearing insert 43 and the bearing support 41. The idler comprises a sealed cylindrical plastic enclosure that houses an axially movable shaft. The shaft comprises a cylindrical bearing section that is kept in protruding position by means of a metal spring inside the enclosure. The spring action ensures proper positioning of the shaft in the end plate bearing. The shaft end is accessible after installation and can be depressed into the housing to push it back out of the bearing and take down the roller tube assembly. In the opposite manner, the shaft is depressed while being installed, and it is placed against the end plate bearing bracket. By lining the depressed shaft up with the shaft bearing, the shaft will automatically spring in place and securely position the tube assembly inside the cassette structure.

Referring again to FIG. 1, snap-on molding 54 of the present invention provides a secure and easy to install aesthetic closure. The molding lock is an integral part of the ceiling bracket.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A cassette system for enclosing window coverings hardware, comprising in combination:
a cassette box which forms at least one tapered slot;
at least one installation bracket which forms at least one tapered cantilever which matches the at least one tapered slot, wherein installation of the cassette box is accomplished by simply lifting the box with the at least one tapered slot onto the at least one tapered cantilever of the at least one bracket.

2. A cassette system for enclosing window covering hardware according to claim 1, wherein the at least one installation bracket is substantially flat and forms holes suitable for mounting on a wall.

3. A cassette system for enclosing window covering hardware according to claim 1, wherein the at least one installation bracket comprises a carrier flange which forms the at least one tapered cantilever and a ceiling mount flange which forms holes suitable for mounting on a ceiling.

4. A cassette system for enclosing window covering hardware according to claim 1 further comprising at least one inside mount end bracket, wherein the at least one inside mount end bracket comprise a wall plate flange and a horizontal support flange, and wherein the wall plate flange substantially matches the cassette box end plates and the wall plate flange forms holes for installation.

5. A cassette system for enclosing window covering hardware according to claim 1 further comprising a roller tube assembly for attaching the window covering and end brackets for mounting the roller tube, wherein the roller tube assembly comprises a roller tube, a spring-loaded idler at one end of the roller tube and an idler shaft which can be depressed against the spring into the roller tube for insertion into and removal from the end bracket at that end of the roller tube.

6. A cassette system for enclosing window coverings hardware, comprising in combination:
a cassette box which forms two tapered slots;
two installation brackets, each of which forms two tapered cantilevers which match the two tapered slots, wherein installation of the cassette box is accomplished by simply lifting the box with the two tapered slots onto the two tapered cantilevers of the two brackets.

7. A cassette system for enclosing window covering hardware according to claim 6, wherein each of the two installation brackets is substantially flat and forms holes suitable for mounting on a wall.

8. A cassette system for enclosing window covering hardware according to claim 6, wherein each of the two installation brackets comprises a carrier flange which forms the two tapered cantilevers and a ceiling mount flange which forms holes suitable for mounting on a ceiling.

9. A cassette system for enclosing window covering hardware according to claim 6 further comprising two inside mount end brackets, wherein each of the two inside mount end brackets comprise a wall plate flange and a horizontal support flange, and wherein the wall plate flange substantially matches the cassette box end plates and the wall plate flange forms holes for installation.

10. A cassette system for enclosing window covering hardware according to claim 6 further comprising a roller tube assembly for attaching the window covering and end brackets for mounting the roller tube, wherein the roller tube assembly comprises a roller tube, a spring-loaded idler at one end of the roller tube and an idler shaft which can be depressed against the spring into the roller tube for insertion into and removal from the end bracket at that end of the roller tube.

11. A cassette system for enclosing window coverings hardware, comprising in combination:
a cassette box which comprises at least one tapered slot;
at least one installation bracket which comprises at least one tapered cantilever which matches the at least one tapered slot, wherein installation of the cassette box is accomplished by simply lifting the box with the at least one tapered slot onto the at least one tapered cantilever of the at least one bracket.

12. A cassette system for enclosing window covering hardware according to claim 11, wherein the at least one installation bracket is substantially flat and forms holes suitable for mounting on a wall.

13. A cassette system for enclosing window covering hardware according to claim 11, wherein the at least one installation bracket comprises a carrier flange which forms the at least one tapered cantilever and a ceiling mount flange which forms holes suitable for mounting on a ceiling.

14. A cassette system for enclosing window covering hardware according to claim 11 further comprising at least one inside mount end bracket, wherein the at least one inside mount end bracket comprise a wall plate flange and a horizontal support flange, and wherein the wall plate flange substantially matches the cassette box end plates and the wall plate flange forms holes for installation.

15. A cassette system for enclosing window covering hardware according to claim 11, wherein at least one tapered slot comprises at least two tapered slots, the at least one installation bracket comprises at least two installation brackets, and the at least one tapered cantilever comprises at least two tapered cantilevers.

16. A cassette system for enclosing window covering hardware according to claim 15, wherein each of the at least two installation brackets is substantially flat and forms holes suitable for mounting on a wall.

17. A cassette system for enclosing window covering hardware according to claim 15, wherein each of the at least two installation brackets comprises a carrier flange which forms the two tapered cantilevers and a ceiling mount flange which forms holes suitable for mounting on a ceiling.

18. A cassette system for enclosing window covering hardware according to claim 15 further comprising two inside mount end brackets, wherein each of the two inside mount end brackets comprise a wall plate flange and a horizontal support flange, and wherein the wall plate flange substantially matches the cassette box end plates and the wall plate flange forms holes for installation.

19. A cassette system for enclosing window covering hardware according to claim 11 further comprising a roller tube assembly for attaching the window covering and end brackets for mounting the roller tube, wherein the roller tube assembly comprises a roller tube, a spring-loaded idler at one end of the roller tube and an idler shaft which can be depressed against the spring into the roller tube for insertion into and removal from the end bracket at that end of the roller tube.
